(19) United States
(12) Patent Application Publication
(10) Pub. No.: US 2009/0030827 A1
(43) Pub. Date: Jan. 29, 2009

(54) SYSTEM AND METHOD FOR MONITORING AND ANALYZING PROCUREMENT PROCESS FOR PROFESSIONAL SERVICES

(76) Inventors: Andrew Burdess, New York, NY (US); Andrew Frumovitz, Marina del Rey, CA (US)

Correspondence Address: TSIRCOU INTELLECTUAL PROPERTY LAW, 655 Central Ave., 17th Floor, Glendale, CA, 91203, US

(21) Appl. No.: 11/782,883

(22) Filed: Jul. 25, 2007

(51) Int. Cl. G06Q 40/00

(52) U.S. Cl. 705/37

(57) ABSTRACT

A system and related method are provided for monitoring and analyzing procurement process for professional services. The system includes a database management system (DMS) stored on a computer-readable medium, having information a plurality of datasets that correspond to information for professional services. The system further includes data analysis and display modules (DADM) that facilitate access to and analysis of the data of the DMS. The system benefits users throughout the procurement process, such as, identifying bid requests that align with the user's capabilities and interests, analyzing data which allows users to evaluate RFPs and develop bidding strategies, aiding in the preparation of proposals, and assisting in the negotiation of contracts after a winning bid, to name a few.

### FIELD OF THE INVENTION

The present invention relates generally to a system and method for providing information regarding a procurement process for contracts and, more particularly, to a system and method for collecting, analyzing, and reporting information regarding the procurement process for contracts for professional services such as those issued by government and government-related entities.

### BACKGROUND OF THE INVENTION

Those in need of professional services spend considerable effort finding qualified, willing and capable providers to satisfy that need. Government and government-related entities routinely require professional services from private industry to satisfy a broad swath of needs. For example, in the course of issuing municipal bonds, the issuing government or government-related entity typically employs several outside firms to perform various professional services such as bond counsel, underwriter, financial advisor, and so on.

Currently, firms wishing to provide professional services to a government or government-related entity typically monitor trade publications to learn of each Request for Proposals (RFP) issued by that government or government-related entity. Bond-issuing entities for most municipalities, for example, publish RFPs in support of municipal bond issuances in periodicals such as The Bond Buyer®. On average, it is only a few weeks between publication of the RFP and the government or government-related entity's deadline for receiving proposals from interested professional services firms

Following the publication of an RFP, professional service providers typically have the opportunity to submit questions to the government or government-related entity regarding the RFP and the related project. The government or government-related entity gathers all the questions and compiles a questions-and-answers document and forwards it to the professional service providers. Following this step, the professional service providers are required to submit proposals responding to the RFP to the government or government-related entity.

The government or government-related entity then reviews and evaluates all of the submitted proposals. Finally, the government or government-related entity then selects at least one professional service provider, and sometimes more than one, based on the submitted proposals. Typically, the parties then negotiate and sign a contract, or the government or government-related entity (after approval by their Board of Directors, if any) otherwise engages the professional service provider who submitted the winning proposal.

As is apparent, the procurement of professional services can often be an involved and complex process. Preparing proposals involves a considerable investment of time and resources. Thus, interested firms must be diligent in monitoring RFPs as they are published and must be discerning in selecting which RFPs merit a proposal.

Under current practices, a firm often spends considerable resources searching for and analyzing numerous RFPs, with the hope of focusing its efforts only on those RFPs for which the firm has a reasonable opportunity of being selected and obtaining a contract. Unfortunately, many firms waste valuable resources because they are unable to evaluate whether they have a realistic chance of success with a given RFP. Furthermore, given the generally brief time available from issuance of a RFP to the government or government-related entity deadline for submission of the corresponding proposal, and the typically broad proposal guidelines in those RFPs, professional services firms struggle to produce proposals that will provide that firm with the greatest opportunities for success in the procurement process.

In addition, proposals submitted by unqualified firms, RFPs which do not reach qualified firms, and the variance in structure and content of submitted proposals for the same RFP all unduly burden the government and government-related entities when attempting to identify, solicit, evaluate and contract with the most appropriate professional service providers. Inefficiencies of the current approach thereby also stress the resources of the requesting government or government-related entity.

It should be appreciated that there remains a need for a system that facilitates the procurement process for professional services relieving the parties from undue effort and expense. The present invention fulfills this need and others.

### SUMMARY OF THE INVENTION

Briefly, and in general terms, the present invention is embodied in a system and related method for providing bidding and contract information to a user, relating to professional services. The system includes a database management system (DMS) stored on a computer-readable medium. The DMS contains a plurality of datasets that correspond to both current and historic information regarding procurement and provision of professional services. The system further includes data analysis and display modules (DADM) that facilitate access to and analysis of the data of the DMS. The system could benefit both the professional services firms as well as government and government-related entities throughout the procurement process by, for example, identifying proposal requests that align with the user's capabilities, analyzing data which allows users to evaluate RFPs and develop bidding strategies, aiding in the preparation of proposals, and assisting in the negotiation of contracts after a winning proposal, to name a few.

In an exemplary embodiment in accordance with the invention, the DMS includes a plurality of provider datasets, entity datasets, request datasets, proposal datasets, and contract datasets.

Each provider dataset has prescribed data elements regarding a provider of professional services, including a unique identifier assigned to the provider.

Each entity dataset has prescribed data elements regarding a purchaser for professional services, including a unique identifier assigned to each entity.

Each request dataset has prescribed data elements regarding a request issued by an entity inviting providers of professional services to submit proposals, including a unique identifier assigned to each request.

Each proposal dataset has prescribed data elements regarding a proposal submitted by a provider of professional services in response to a request issued by an entity, including a unique identifier assigned to each proposal.

Each contract dataset has prescribed data elements regarding a contract for professional services between an entity and a provider of professional services, including a unique identifier assigned to each contract.

In a detailed aspect of an exemplary embodiment, the DADM enables access to the data of the DMS by users through a client device, and enables searches of the DMS by users identifying search parameters directed to one or more data elements attributable to one or more datasets of the DMS.

In another detailed aspect of an exemplary embodiment, the DADM enables analysis of the data of the DMS by users through a client device, and enables searches of the DMS by users applying analytical tools directed to one or more data elements attributable to one or more datasets of the DMS.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a simplified block diagram of a system for collecting, analyzing and reporting information regarding the procurement process in accordance with the present invention, depicting a system database in communication with a plurality of client devices.

FIG. 2 is a simplified block diagram of a database structure and management system for use with the system of FIG. 1.

FIG. 3 is an exemplary home page for the system of FIG. 1.

FIG. 4 is an exemplary user-input webpage produced by the system of FIG. 1.

FIG. 5 is an exemplary page depicting bid matching results produced by the system of FIG. 1.

FIG. 6 is an exemplary page depicting detailed information for an RFP, usable with the system of FIG. 1.

FIG. 7 is an exemplary page depicting detailed analysis produced by the system of FIG. 1, depicting an output from an analytical tool comparing a contract term across several years.

FIG. 8 is an exemplary page depicting detailed analysis produced by the system of FIG. 1, depicting an output from an analytical tool that graphs trends within an industry.

FIG. 9 is an exemplary page depicting detailed analysis produced by the system of FIG. 1, depicting data from several proposals in response to a request.

FIG. 10 is an exemplary page depicting detailed analysis produced by the system of FIG. 1, depicting an output from an analytical tool comparing terms of a winning proposal and the resulting contract.

### DETAILED DESCRIPTION OF THE PREFERRED EMBODIMENTS

In this section, the present invention is described in detail with regard to the figures briefly described above. As such, the following terms are used throughout the description. For purposes of construction, such term shall have the following meanings:

The terms “client,” “customer,” and “user,” unless otherwise specified, are intended to refer to any person, group of people, business, government entity, government-related entity, or other organization that uses the system.

The terms “entity,” “entities” and “agency,” unless otherwise specified, are intended to refer to organizations that contract or otherwise employ outside firms or third parties to perform professional services on behalf or in support of the organization. Such entities can include government and government-related organizations.

The terms “provider” and “providers,” unless otherwise specified, are intended to refer to organizations or firms that seek to perform, or perform professional services on behalf or in support of an entity.

The terms “request,” “request for proposal,” “RFP,” “request for qualifications” “RFQ” and “bid request,” unless otherwise specified, are intended to refer to an invitation by an entity to providers to submit proposals, or otherwise provide information, requested by the entity to aid in selecting a provider to perform professional services on behalf or in support of the entity.

The terms “proposal” or “bid,” unless otherwise specified, are intended to refer to a proposal submitted by a provider to an entity in response to an RFP, which proposal is intended to assist the provider in securing a contract to provide professional services on behalf or in support of the entity.

The terms “contract” or “contracts,” unless otherwise specified, are intended to refer to any agreement between an entity and provider or providers to provide professional services on behalf or in support of the entity.

Referring now to the drawings, there is shown an exemplary embodiment a system, identified by reference numeral 10, for collecting, analyzing and reporting information regarding the procurement process for professional services, in accordance with the invention. The system benefits users throughout the procurement process, such as, identifying bid requests that align with the user's capabilities and interests, analyzing data which allows users to evaluate RFPs and develop bidding strategies, aiding in the preparation of proposals, and assisting the negotiation of contracts after a winning bid, to name a few.

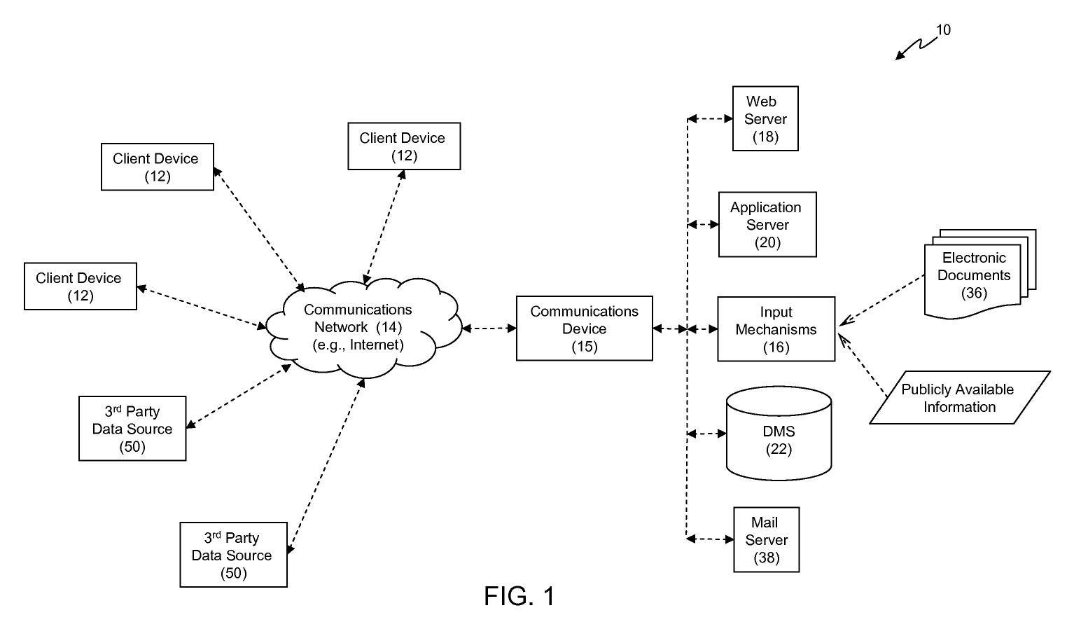

With reference now to FIG. 1, there is shown a simplified block diagram of the system 10, having a plurality of components in communication with one another and with client devices 12, via a communications network 14 and through at least one communications device 15. Connections between components are shown using double-sided arrows, which may be physical, fiber optic, wireless or any other type of communications link. Additionally, other types of communication means and/or protocols can be used, for example, a customer can transfer information by means of a memory card and memory card reader.

The system 10 includes input mechanisms 16 that can be used to provide data, electronic documents 36, and other information to the system. Input mechanisms include, for example, scanners, recorders, phones, facsimile machines, keyboards, touch screens, mice, and any other type of device usable for providing input storable in digital format into the system.

The web server 18 stores and runs applications for a website of the system 10 and is connected to the communications network 14 through the communications device 15. Multiple servers may be included to accommodate high-volume demand on the system. The application server 20 stores the applications for the website. The application server also runs applications that direct the data and information in among the various components, modules, and servers of the system. The mail server 38 runs applications that process e-mail communications for the system, to include transmission of emails to clients.

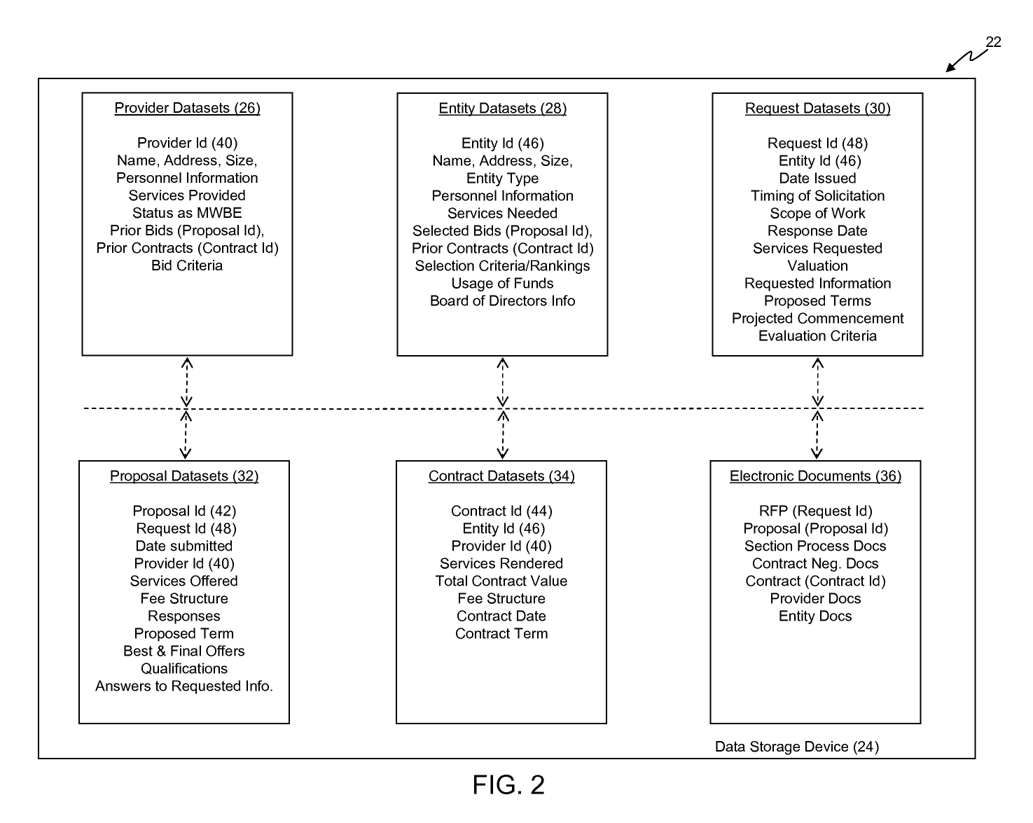

With reference now to FIG. 2, the DMS 22 includes a data storage device 24 having data dispersed among provider datasets 26, entity datasets 28, request datasets 30, proposal datasets 32, and contract datasets 34. The DMS is further configured to store electronic documents 36 for use by the system. Information from the electronic documents are also stored in the various datasets. Additional information regarding these datasets will be discussed throughout this description. It will be appreciated that data can be organized into various different database configurations without departing from the present invention. In the exemplary embodiment, each dataset is stored in an individual database; however, in other embodiments, various other database configurations can be used, singly or in combination, such as, relational, distributed, hierarchical, object-oriented, object-relational, temporal, and XML data stores, and so on, on single or multiple data storage devices.

The provider datasets 26 of the DMS 22 include information regarding individuals, firms, businesses, and other organizations that provide professional services to others. The provider datasets 26 include a number of different data items with reference to each of the providers. Each provider within the dataset has a unique identifier, i.e., a provider id 40, for use by the system 10. Information specific to the provider such as, but not limited to the name, address, and the size of a provider are also stored within the dataset for that provider. Number and locations of offices of a provider can also be included. In addition, the types of professional services that the providers can render can also be included.

Prior submitted bids and prior awarded contracts of providers can also be linked through the provider dataset 26. As discussed in detail below, each prior bid and each prior contract stored in the DMS 22 is assigned a unique identifier, i.e., proposal id 42 and contract id 44. These identifiers are stored within several datasets, including the provider dataset 26 of a provider. For example, if ABC corp. had five prior proposals and two contracts within the DMS, a unique identifier would be assigned to each of these seven items. Those identifiers would be stored, among other locations, in the dataset for ABC corp.

Information regarding key personnel of a provider can also be included in the provider dataset 26. For example, the dataset can include names, locations, years of experience, and technical expertise of such key personnel. In addition, key personnel can be linked to prior submitted bids and prior awarded contracts in which the personnel were involved. Based on information within the DMS 22, valuable information can be accessed about providers, such as, number of current contracts, percentage of success of submitted proposals for a provider, and percentage of success of submitted proposals for a provider to a specific entity.

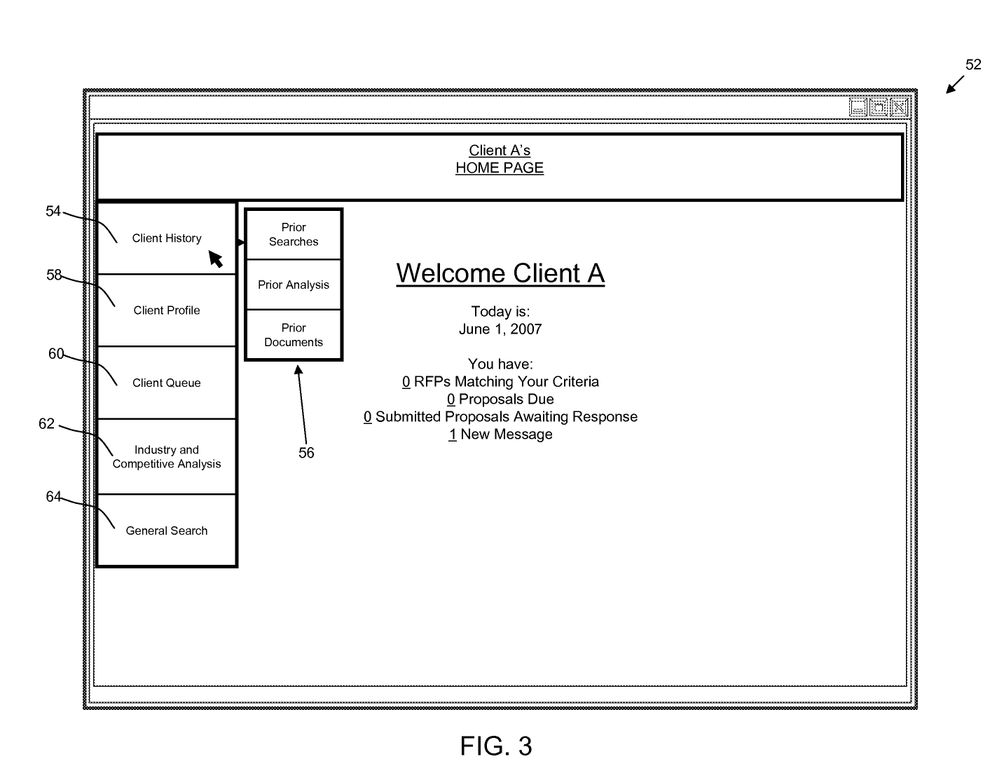

With reference now to FIG. 3, there is shown a client-specific homepage 52. This page is presented after a client logs into the system, e.g., by providing a user name and password or other methods of identification known in the art. In the exemplary embodiment, the client-specific homepage provides direct access to the following five different areas: “Client History,” “Client Profile,” “Client Queue,” “Industry and Competitive Analysis,” and “General Search.”

Through the Client History tab 54, a client can access prior searches, prior analysis performed and prior documents accessed during previous use of the system, as shown in a rollout menu 56 associated with the Client History tab. The “Prior Documents” link leads the client to a webpage that provides an index of all prior bids, winning contracts, and other electronic documents involving the client or saved by the client during previous use of the system.

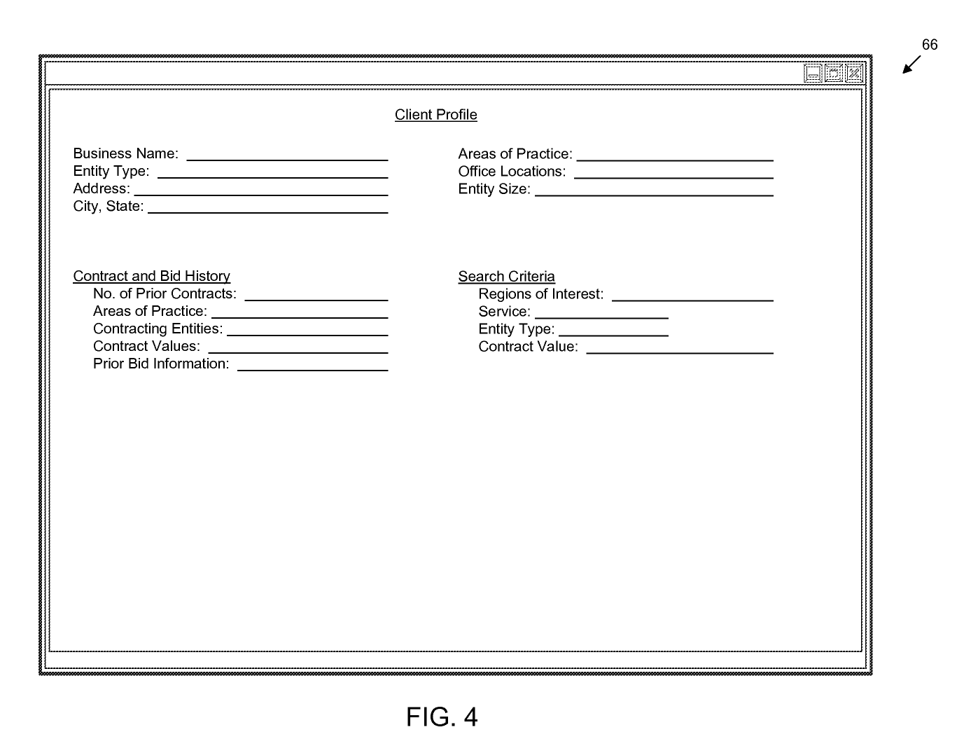

The Client Profile tab 58 directs the client to a webpage 66 (FIG. 4) that allows the client to provide detailed information about itself, as well as setting criteria for RFP-matching purposes.

The Client Queue tab 60 provides access to an index of all RFPs that match the client-established profile, as discussed in detail below with reference to FIGS. 4.and 5.

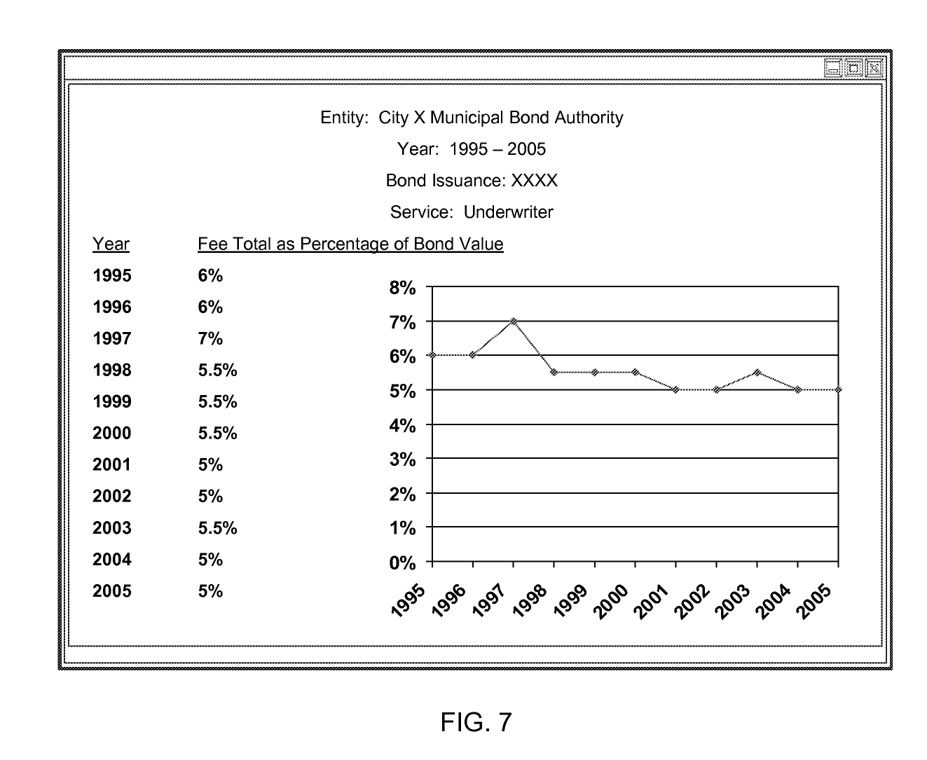

The Industry and Competitive Analysis tab 62 allows the client to query the database for a wide array of information on the relevant industry and competitors, and apply analytical tools to that data to develop strategies for, and improve efficacy of client bidding. Examples of such analyses are provided below with reference to FIGS. 7-10 as well as with regard to the detailed example provided under the “Example” heading below.

The General Search tab 64 allows the client to search the database along many different search criteria which results in the presentation of data to the client in concise and usable formats, with linkages to deeper content and additional, analytical tools.

With reference now to FIG. 4, a user can complete its Client Profile 58 by providing information to the system 10 over the communications network 14 through a client-profile webpage 66. The profile webpage queries the user to provide information for inclusion in the provider dataset 26 for the user, such as, name, areas of practice, entity type, office locations, main address, and business size. A user can further provide detailed information regarding prior contracting experience. In addition, the user can identify search criteria for the types of bid requests of interest. The provided information is stored in the provider datasets 26 for use by the system, such that each provider has a corresponding dataset. The system then draws on its database of prior bids and prior documents from other datasets that are responsive to the search criteria to further populate the provider dataset 26.

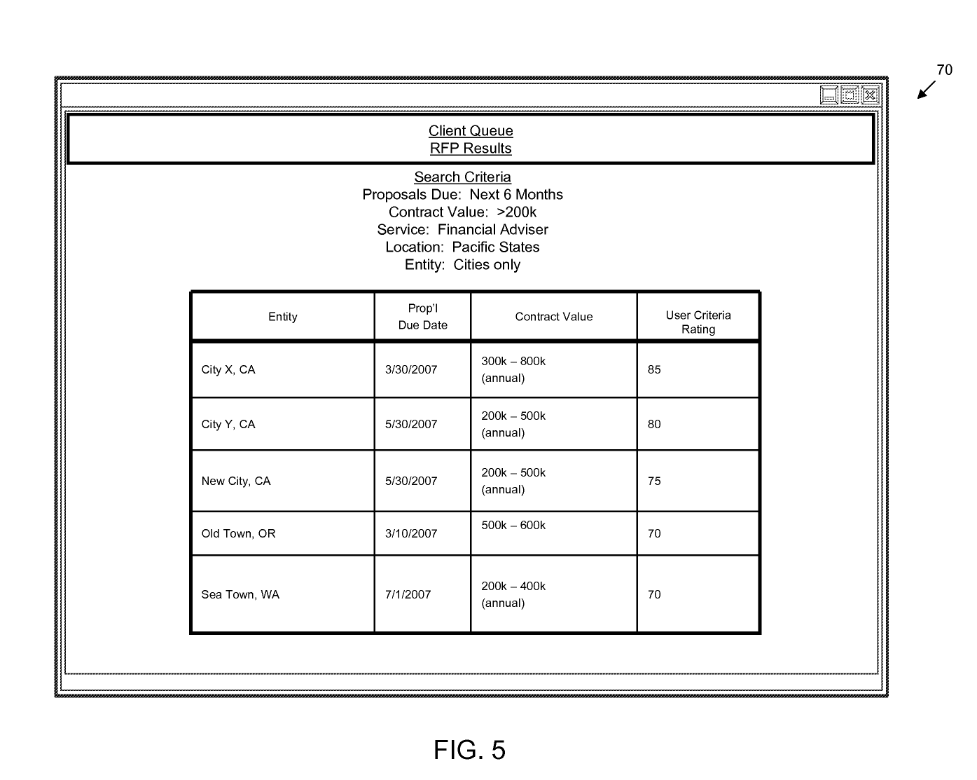

For example, the system 10 is configured to automatically notify the user of bid requests satisfying the search criteria established in the Client Profile 58. An example of such search criteria and results is discussed below with reference to FIG. 5. The system can also notify the user of a bid request that might be of interest to the user via email 38 and/or by moving the bid request into the Client Queue 60 based on the user's profile stored in the provider datasets 26.

Referring again to FIG. 2, the entity datasets 28 of the DMS 22 includes relevant information for entities that contract or otherwise employ providers on behalf or in support of the entity. Each entity is assigned a unique identifier, i.e., an entity id 46, for use by the system. The name, address, and entity type are stored within the dataset for that entity and are associated with the corresponding entity id. For government and government-related entities, the corresponding level of government, such as city, county, State, or federal, can also be stored. Number and locations of offices of an entity can also be included. Prior bids received and prior contracts of entities can be linked through the entity dataset, via corresponding proposals id 42 and contracts id 44. The DMS 22 can also include electronic versions of RFPs, prior evaluation documents, prior Board of Directors approvals, prior questions-and-answers documents, and other prior, related entity records. Information regarding key personnel of an entity can also be included in the entity dataset. In addition, key personnel can be linked to prior bids and prior contracts in which the personnel were involved.

As mentioned above, information from electronic documents is also stored in the various datasets and is linked to the source document, which enables clients to compile useful information to aid in the procurement process. For example, a client can search all prior awarded contracts resulting from RFPs which are similar to the current RFP for an entity in a given time horizon to find out the prior awarded fee sizes and structures.

As shown in FIG. 1, the system 10 is configured to capture information regarding entities that have proposal information and/or contract information. This and other information can be gathered to populate entity datasets 28 over the communications network from third-party data sources 50, e.g., personnel of the entities themselves, publicly available information (i.e., subscription-based data sources and publicly available information over the Internet), and/or requests for documents filed with entities.

Entities themselves may voluntarily enter information regarding the procurement process into the system 10 to facilitate the bidding process. Public documents, such as Official Statements of governments and government-related entities, can also be entered, which Official Statements provide details of the following; description of the organization and its purpose, board membership and political affiliation, staff positions and listings, brief biographies, to name a few. Further, newsfeeds that refer to entities can be included (such information can be used by the system to predict or otherwise determine triggering criteria that could cause an entity to issue requests, even prior to that request being issued).

In addition to publishing information on their own initiative, government and government-related entities are often obliged to provide certain information upon request. Such disclosure obligations can emanate from various sources such as custom, regulation and statute (e.g., freedom of information laws (FOIL)) derived from one or more levels of government, whether local, State or federal. The DMS 22 can include information requested and received pursuant to such obligations. For example, operators of the system 10 can periodically and systematically gather data for the DMS through such requests. Furthermore, the system can allow users to submit requests for documents not already contained in the DMS, and the system can, upon receipt of such submissions, file appropriate requests with the related entity or entities. When the system receives the related documents from the relevant entity or entities in response to the system's request, the system can then process the data and store it in the appropriate datasets for retrieval by clients.

Entities can vary in their compliance, receptivity, and timeliness in response to document requests submitted pursuant to such obligations, whether custom, regulation or statute. Information regarding an entity's compliance, receptivity, and timeliness can be included in the dataset or datasets associated with the entity. The DMS 22 includes contact information for entities in the dataset for that entity. The DMS can further include instructions or guidance for soliciting information to an entity pursuant to the entity's disclosure obligations. Based on this information, the system 10 can automatically generate a request for submission to an entity in response to a user's submission requesting documents that are not currently within the DMS. Through user submissions and FOIL automation, the system can perpetuate extensive and ongoing population of the DMS.

FOIL automation can be initiated by the client from the General Search page, e.g., through General Search tab 64 (FIG. 3). From General Search, a user can identify a set of documents associated with a particular RFP, entity, or contract type, not otherwise within the DMS 22 in full, and request that those documents are provided. Based on the client's request, the system 10 accesses information from the DMS relevant to the request, such as the entity's contact information, document request instructions, and so on, and generates a document request to be submitted to the entity. While the system personnel might be required to review the solicitation prior to submission to an entity, in the exemplary embodiment, the request can be generated and submitted by the system without need for human intervention via facsimile, electronic mail or standard post as the entity provides.

The request datasets 30 of the DMS 22 include detailed data from historical bid requests and current bid requests. As previously mentioned, each request within the DMS is assigned a unique identifier, request id 48. Each request dataset 30 includes an entity id 46 corresponding to the entity that issued the request. In this manner, the system can correlate information for an entity with information for the particular request. The request dataset 30 further includes information such as the issue date of the request, due date for submitting responses, types of professional services requested, potential valuation of the subsequent contract, questions to bidders, term of the contract, and other pertinent information (such as a synopsis of the request), as well as linkage to the complete RFP document in the document dataset 36. RFPs may capture the following; the scope of work and any changes to it, the timing of the solicitation (whether a full contract term has been concluded), the proposed term, and maximum contract amount, to name a few.

The proposal datasets 32 include detailed information captured from proposals submitted in response to a request. Each proposal dataset 32 is assigned a unique proposal identifier 42 to facilitate relationships with other information within the DMS 22. For each proposal stored in the DMS, the proposal dataset 32 includes request id 48 that corresponds to the request for which the proposal was prepared as well as a provider id 40 that corresponds to the provider that prepared the proposal. Each proposal dataset 32 further includes fee structure, responses to questions posed by the entity, services offered, experience, and other pertinent information. Such information for each element of the proposal dataset 32 can be provided as searchable text or can be selected from a list of items that correspond to a particular element of the proposal dataset 32. For example, the fee structure element of the proposal dataset 32 can be provided as a selectable list of various types of fee structures used for professional services, such as a list comprising flat fee; hourly rates; tiered; mixed: flat fee and hourly; mixed: flat fee and tiered; and mixed: hourly and tiered.

Once an entity completes its selection process from the proposals submitted, the contract will be negotiated and signed by the parties. Details from the completed contract are stored by the DMS 22 in the contract dataset 34. Each contract dataset 34 is assigned a unique contract identifier 44 by the system to relate to other information within the DMS 22. For each contract stored in the DMS, the contract dataset 34 can include a contract id 44 for that contract, an entity id 46 for the entity that provided the contract, and a provider id 40 for the provider that won the contract. Each contract dataset 34 further includes information related to the specific details of that contract, such as services rendered, total contract value, fee structure, contract date, and other contract terms.

The DMS 22 is further configured to store electronic versions of documents generated during the procurement process. Examples of such documents include RFPs, proposals, submitted bids, questions-and-answers documents, Board of Directors meeting minutes, evaluation documentation and contracts, to name a few. Such documents can be uploaded to the DMS by users of the system, retrieved by the system from third-party data sources 50 through the communications network 14, or added to the DMS via input mechanisms 16, as discussed above.

The system 10 includes Data Analysis and Display Modules (DADM) 52 that facilitate access to and analysis of the data from the DMS 22. The DADM comprises a number of analytical tools that benefit users throughout the procurement process, such as, identifying bid requests that align with the user's capabilities and interests, analyzing data which allows users to evaluate RFPs and develop bidding strategies, aiding in the preparation of proposals, and assisting in the negotiation of contracts after a winning bid, to name a few. Examples of such tools are discussed in detail below.

Referring now to FIG. 5, the DADM 52 is configured to generate a webpage 70 displaying RFPs that satisfy prescribed search criteria, as set forth on the Client Profile webpage 66 (FIG. 4), for example. As mentioned above, a user can identify a number of different criteria that align with the user's capabilities and interests. In the example provided in FIG. 5, the user, a financial adviser, requests that the system identify RFPs that are due within the next six months having a contract value greater than $200,000, geographically located with Pacific States, and limited by entity-type to cities only. Based on those criteria, the DADM 52 identified five proposals, as shown in FIG. 5.

The DADM is further configured to assign a rating to each of the RFPs. The rating value is based on how closely the RFP correlates to the user's search criteria. For example, an RFP that satisfies all of the search criteria would have a higher rating than an RFP that does not satisfy all of the search criteria. In addition, certain search criterion can be given higher weight than other search criterion. For example, an RFP having a comparatively higher potential contract value can result in a higher rating than RFPs having comparatively lower potential contract values. If the user finds one of the RFPs to be of particular interest, the user can then retrieve additional detailed information related to that RFP by selecting it, which will cause the DADM 52 to display a webpage having the RFP information.

Various other approaches can also be used for generating rating criteria. For example, rating values for RFPs could be based, at least in part, on historical trending information. In one approach, the DADM 52 would analyze prior contracts and/or winning bids for like services from the entity issuing a particular RFP. One or more parameters, such as overall contract value, hourly rates, or contract duration, could be identified from the prior contracts and/or winning bids from that entity. The DADM 52 would analyze the trend of those parameters over a prescribed time period. Favorable trends in one or more of the prescribed parameters would contribute to a favorable rating value for the prescribed RFP.

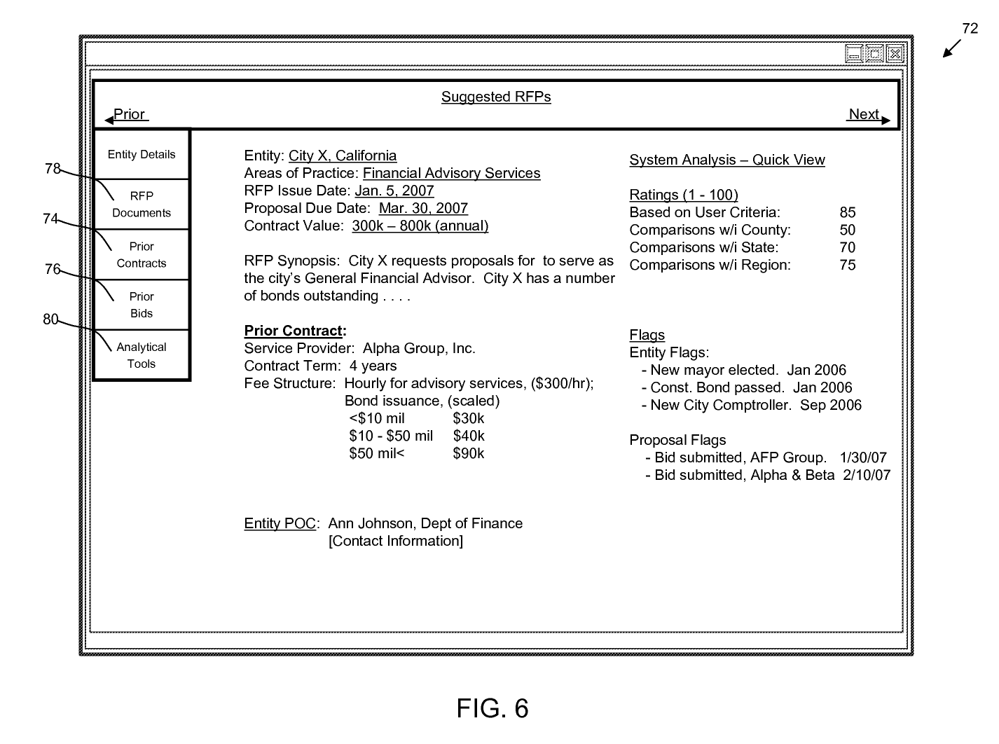

With reference now to FIG. 6, a webpage 72 is shown depicting detailed information for the first RFP listed on the webpage 70. The DADM 52 retrieves information from the request dataset that corresponds to the matching RFP and the issuing entity. In addition, the DADM 52 further retrieves data relating to any prior contract from the same entity for the same or similar services. In the exemplary embodiment, prior contract information is displayed in an upper left quadrant of the webpage. This information can benefit the user in determining whether to respond to the bid request. The user can access an electronic version of the prior contract by selecting “Prior Contracts” tab 74. The user can also access electronic versions of the prior bids submitted to the entity by selecting “Prior Bids” tab 76. Users can also access components of prior contracts or prior bids such as fees awarded or fees proposed using search tools.

The DADM 52 is configured to further rate the selected proposal based on a number of other criteria. In the provided example, the DADM assigns four different rating values. The first is based on the user criteria, as mentioned above. The second rating compares the selected proposal to other similar proposals issued by entities within the same county as the issuing entity. The third rating compares the selected proposal to other similar proposals issued by entities within the same State as the issuing entity. The fourth rating is based on proposals within the same region.

The DADM 52 further displays selected flagged information gathered from the DMS 22. In the example, City X has recently undergone an election, the results of which were gathered by the system (for example from newsfeeds), and stored on the entity dataset for City X. From the present page, the user can access an electronic version of the request by selecting the “RFP Documents” tab 78. The user can conduct additional analyses of the proposal by selecting “Analytical Tools” tab 80, which allows the user to access the numerous tools provided by the system 10.

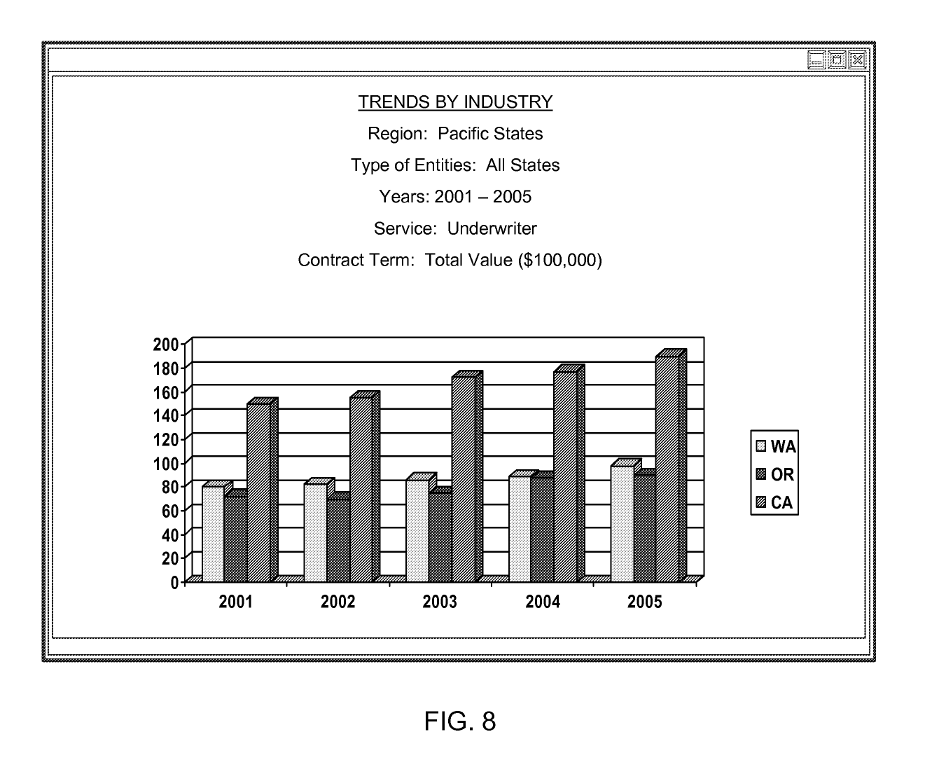

As shown in FIG. 7, the analytical tools include a feature that will display one or more characteristics of winning proposals and/or terms of completed contracts over a prescribed time period. In this example, the DADM 52 calculates the fee total as a percentage of bond value for the service of underwriter based on prior awarded contract data within a certain criteria from the years 1995 through 2005. A user can use this tool to ensure that its current proposal is in line with trends in the industry. In this manner, the user can prepare a competitive proposal, increasing its chance of being selected by the entity. Another example of trend information is depicted in FIG. 8.

As shown in FIG. 8, the system can provide historical information for prescribed criteria across entity types and geographic regions. In the example presented, trending information is provided relating to the professional service of underwriting, with regard to contracts awarded in the Pacific States (Washington, Oregon, and California), from the years 2001 through 2005. The chart depicts the total contract value of such contracts by State, allowing the user to determine trends across a geographic region of interest.

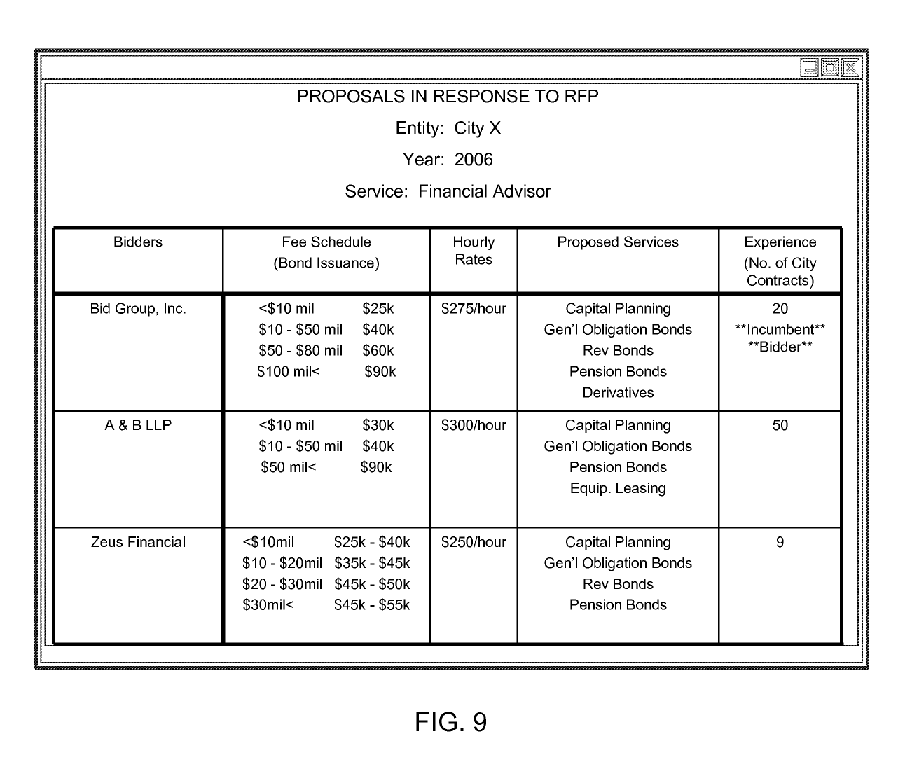

To further aid in preparing a proposal, the system 10 can display each of the proposals submitted in response to a prior request or prior requests from the same entity. The system can also display prior proposals based on other user-selected criteria. As shown in FIG. 9, data from prescribed proposal datasets 32 are displayed to include selected items, such as fee schedule, hourly rates, proposed services, and experience. The system 10 further identifies which proposal was selected by the entity. This enables the user to assess the entity's decision-making criteria.

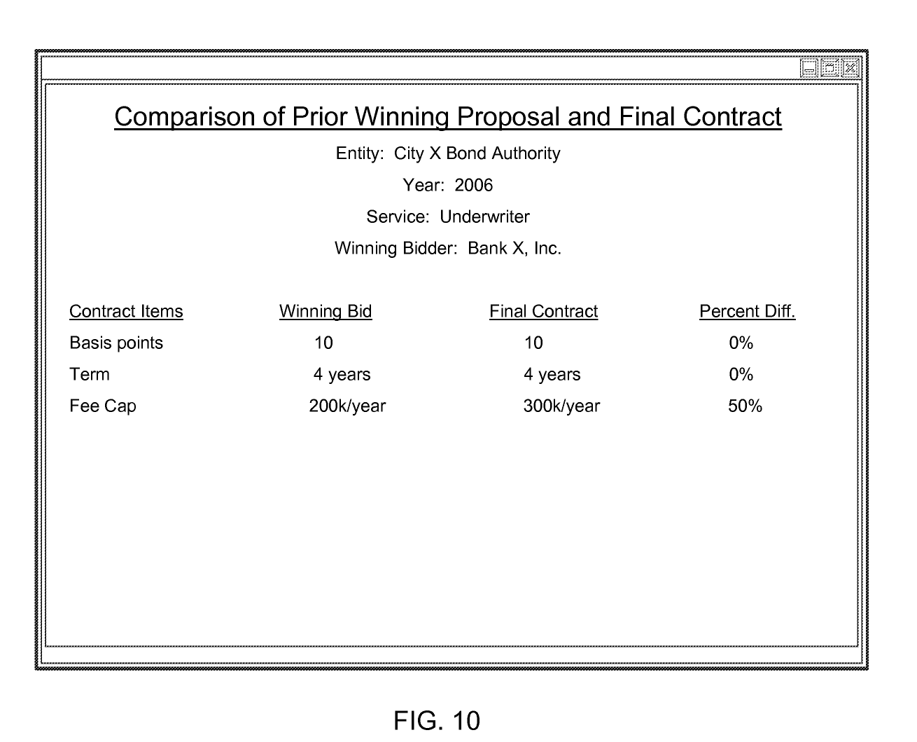

With reference now to FIG. 10, the system 10 can aid a user during the contract negotiation stage. In this example, the DADM 52 compares prior winning proposals to the resulting contracts. Given this information, the user can structure an appropriate negotiation strategy after receiving notification of a winning bid, but prior to, and during the negotiation of the final contract that follows after, and correlates to the winning bid.

To further demonstrate the benefits of the system the following example is provided. This example should be construed only as illustrative, and it does not limit the disclosure or the claims.

### EXAMPLE

The client of this example is a mid-sized law firm based in Los Angeles with offices throughout California. The client has had limited, prior success winning bids to provide bond counsel to local entities on short-term issuances. The client believes there may be a much larger market for providing bond counsel on issuances, and decides to subscribe to the system 10 to better understand the market and develop a strategy for growing the client's bond counsel business.

The client visits a homepage for the system 10 and enters a username and password. Once logged on, the client is presented a client-specific homepage. Because this is the client's first visit to the website, the client has no prior searches to review.

First, the client wishes to determine the geographic scope of the market the client is interested in servicing. To do so, the client navigates to the General Search page to access the geographic proximity of all law firms providing bond counsel to entities issuing bonds. The system generates a graph that shows 75% of the contracted firms are located within 50-100 miles of the issuing entity; 20% are located within 100-200 miles of the issuing entity; 4% are located within 200-500 miles of the issuing entity; and 1% are located more than 500 miles from the issuing entity.

The client evaluates these results for a moment, and is unsatisfied. The client realizes that because many large firms have offices in almost every major city, the result is skewed toward large firms with satellite offices located within 100 miles of the issuing entity. The client does not believe his mid-sized firm needs to only bid on RFPs from entities located in California. To test this theory, the client now refines the inputs on the General Search page to create two inquiries: geographic proximity of mid-sized firms providing bond counsel to issuing entities for long-term issuances in the preceding 10 years, and geographic proximity of mid-sized firms providing bond counsel to issuing entities for short-term issuances in the preceding 10 years (in these inquiries, the criteria that compose a mid-sized firm, such as number of attorneys, number of offices, etc., are already defined by the system).

These two new searches now result in two new graphs validating the client's theory. The long-term issuance graph for mid-sized firms shows 15% of the contracted firms are located within 50-100 miles of the issuing entity; 20% are located within 100-200 miles of the issuing entity; 45% are located within 200-500 miles of the issuing entity; and 20% are located more than 500 miles from the issuing entity. The short-term issuance graph shows similar results. On all of the prior graphs, by clicking on the actual percentage displayed numerically the client can go deeper into the data and retrieve an index of all firms and entities within that data subset.

The client now decides to perform a competitive analysis to refine the geographic scope further. The client queries the geographic proximity in 100-mile increments of all contracts for services won during the preceding 10 years by its key competitor—the largest mid-sized law firm that, just as with client's firm, only has offices in the State of California. That inquiry shows that 95% of that key competitor's bond counsel business is within the Western States of California, Oregon, Washington, Nevada and Arizona. The client decides to likewise focus on these Western States.

Now that the client has identified his geographic scope of interest, the client wishes to determine whether the client should focus on bidding to provide bond counsel on long-term or short-term issuances. The client seeks answers to the following questions to enable that determination: 1) which are more frequently offered, and what are the important industry trends between the short-term and long-term markets?; 2) what is the relative fee structures and overall fees for each segment?; 3) is the client's firm capable to winning contracts for bond counsel on long-term issuances?; and 4) who are all of the key competitors?

From the General Search page, the client conducts an analysis to determine the frequency of long- versus short-term issuances in the Western States. The resulting graph shows the long-term issuances well out-pace short-term issuances. The client then executes a similar query, but this time broken down by year over the prior 10 years. The result is two bar graphs, with bars for each respective year, not only showing more long-term issuances, but also showing the trend that long-term issuances over the prior 10 years are increasing, as opposed to relatively flat growth in the number of short-term issuances year after year for the same period of time. By clicking on any single bar on the graph, the client can click-through to an index of all issuances in the relative year, and then click-through even further to get into a particular document-set for any given issuance.

The client now saves these charts to the “Prior Analysis” section of the Client History area. Returning to the General Search page, the client decides to run a similar query over the preceding 10 years, but rather than number of issuances, the client uses value of issuances as the key criteria. This query shows similar results, with the long-term market in the Western States growing, and the short-term market fairly stagnant. Lastly, and most convincingly, the client runs a similar query utilizing aggregated annual legal fees instead of value of issuances, and the system generates results indicating that the fees for bond-counsel for long-term issues not only exceed those for short-term issues, but also are growing at an astronomical pace. The client saves these charts into Prior Analysis as well.

The client next runs a search to determine the exact number of long-term issuances during the preceding 10 years for which the entities in the Western States retained mid-sized firms. The system indicates that 250 issuances from Western States entities were serviced by mid-sized law firms during the preceding 10 years. The client now queries how many firms serviced those 250 issuances. The result is 60. The client now runs a listing of those 60 firms, ordered from most contracts serviced to least over the preceding 10 years. Six of the 60 firms top the list with 10 contracts each. The other 50 firms range from one to five contracts each. The client identifies those top six firms as its key competitors in the long-term marketplace. The client concludes that while certain mid-sized firms are repeat players in the Western States market, no one firm is dominant, and therefore there is room for the client to move into this market. The client saves this analysis to the Prior Analysis section as well.

Based on the above analysis, the client decides to focus on long-term issuances in the Western States. The client clicks to the Client Profile to set up the client criteria for RFP-matching. Using drop-down menu boxes under “Set Client Profile” on the Client Profile page, the client establishes search criteria in the following categories:
Industry: bond counsel
Type of issuances: long-term
Value of the issuance: more than $100,000,000
Geographic scope: Western States
Type of entity (i.e. local, city, States): all
Time period: current, and 5 years prior

Once the Client Profile is established, the client visits the Client Queue. Using drop-down menu boxes under “Set Queue Profile” on the Client Queue page, the client establishes queue protocol in the following categories:
Number of matched Client Profile criteria to enter Client Queue: 4 of 6
Updates via email: yes, upon publication
Update Client Queue (upon publication daily weekly monthly): upon publication
Arrange Client Queue (chronologically, geographically, entity type, size of issuance): chronologically
Include current prior and/or future: current, prior (5 years) and future
Drop prior: 5-year deadline
Email RFP expirations: yes, weekly

Setting the Queue Profile allows the client to determine how the Client Queue will be organized. It also allows the client to manage the notification process. So, based on the above criteria, the Client Queue will only be populated with notices of RFPs which meet at least four of the six criteria set forth in the Client Profile. The client will receive email updates of every new RFP notice upon publication of that notice in the database, as well as emails about upcoming RFPs based on pending expiration dates of current contracts. The system will also update the Client Queue upon publication of current RFPs, and with future RFPs based on pending expiration dates of current contracts.

The client has chosen to have the Client Queue arranged chronologically, with upcoming RFPs (based on pending expiration dates of current contracts) and then current RFP notices at the top, and then index entries of the complete datasets (full RFPs, proposals, contracts, etc.) of past matches going back five years (each index entry in the Client Queue has click-through capability to access the actual documents). When prior document-sets exceed the 5-year window, the system drops them off the Client Queue. When current RFPs are approaching submission deadlines, the system will email the client a deadline reminder list for the upcoming week. (All emails from the system to the client will have links so that client can click the link, open an Internet connection, and access the related document and/or document-set in the system directly.)

Once the client completes the Client Profile and the Client Queue preferences, the Client Queue immediately begins populating with current RFP notices, and past document-sets that meet the relevant criteria.

Once the Client Queue is initially populated, the client visits the Client Queue and becomes interested in a current RFP for bond counsel issued by the Washington State Turnpike Authority (WSTA). By clicking on the index entry in the Client Queue, the client sees this RFP notice meets all six Client Profile criteria, and is also given the contact information for the WTSA to request the full RFP (as the full RFP is not yet available through the website). This information is also communicated to the client through an email notice automatically sent by the system.

The client now decides to analyze this WTSA bid further. The client's next step is to visit the General Search area. On the General Search page, the client uses drop-down menu boxes to conduct a search for all long-term issuances from the WTSA for the prior 10 years. The system generates an index of three procurements, from the years 2004, 2001 and 1998, respectively. The system does not contain any documents for this entity prior to 1998.

At this point, the client considers utilizing the automated bid retrieval service from the company on the General Search page to have the company file additional FOIL requests for WTSA documents going back before 1998. Upon further consideration, the client chooses not to do so at this time.

The client now refines his search on these three document-sets to show value of the issuances, bond counsel utilized, fee structure, and legal fees. What results is a matrix with the years 1998, 2001 and 2004 across one axis, and the bond value, bond counsel identity, fee structure and legal fees across the other axis. Within each category is the responsive information. By clicking on the year, the client can see the entire set of documents related to the issuance. By clicking on a value such as fee structure, the client can see the winning fee structure in the proposal and in the final contract. Based on this information, the client decides to contact WTSA to request the RFP. The client also saves this search to “Prior Searches,” so when the RFP arrives the client can go through each prior document-set in detail and evaluate what distinguished prior winning bids from losing bids before preparing its own bid.

Before logging off the system, the client returns one last time to the Industry and Competitive Analysis area. The client conducts a search of the WTSA to obtain global and industry specific information regarding the entity, such as the percentage of incumbent firms and minority business enterprises previously selected by the WTSA. The client conducts another query for WTSA and calls up a profile of the employees and decision-makers within the entity. The client saves this WTSA information into Prior Analysis for future reference as well.

Over the next few weeks, the client repeatedly accesses the data generated from these searches, and further refines and uses the searches as an aid in the preparation and submission of the proposal.

The client does win the proposal. After being informed it has submitted the winning proposal, the client conducts a comprehensive analysis of the differences between prior winning proposals and each corresponding, prior final contract with the WTSA, and uses the data from that analysis to negotiate the client's own final contract with the WTSA.

It should be appreciated from the foregoing that the present invention provides a system and related method for providing bidding and contract information to a user, relating to professional services. The system includes a database management system (DMS) stored on a computer-readable medium, having information for a plurality of datasets that corresponds to information for professional services. The system further includes data analysis and display modules (DADM) that facilitate access to and analysis of the data of the DMS. The system benefits users throughout the procurement process, such as, identifying bid requests that align with the user's capabilities and interests, analyzing data which allows users to evaluate RFPs and develop bidding strategies, aiding in the preparation of proposals, and assisting in the negotiation of contracts after a winning bid, to name a few.

Although the invention has been disclosed in detail with reference only to the exemplary embodiments, those skilled in the art will appreciate that various other embodiments can be provided without departing from the scope of the invention. Accordingly, the invention is defined only by the claims set forth below.

What is claimed:

1. A system for providing bidding and contract information to a user, comprising:
a database management system (DMS) having data stored on a computer-readable medium, the DMS including
a plurality of provider datasets, each provider dataset having prescribed data elements regarding a provider of professional services, including a unique identifier assigned to the provider,
a plurality of entity datasets, each entity dataset having prescribed data elements regarding a purchaser for professional services, including a unique identifier assigned to each entity,
a plurality of request datasets, each request dataset having prescribed data elements regarding a request issued by an entity inviting providers of professional services to submit proposals, including a unique identifier assigned to each request,
a plurality of proposal datasets, each proposal dataset having prescribed data elements regarding a proposal submitted by a provider of professional services in response to a request issued by an entity, including a unique identifier assigned to each proposal, and
a plurality of contract datasets, each contract dataset having prescribed data elements regarding a contract for professional services between an entity and a provider of professional services, including a unique identifier assigned to each contract; and
data analysis and display modules (DADM) having instructions stored on computer-readable medium and a processing assembly in communication with the computer-readable medium for execution of the instructions, such that the DADM enables access to and analysis of the data of the DMS by users through a client device, the DADM enabling searches of the DMS by the users by identifying search parameters directed to one or more data elements attributable to a dataset of the DMS.

2. A system as defined in claim 1, wherein the plurality of provider datasets includes a plurality of data elements selected from a list consisting of contact information, services provided, bid criteria, historical bid information, and historical contract information.

3. A system as defined in claim 1, wherein the plurality of entity datasets includes a plurality of data elements selected from a list consisting of contact information, entity type, location, services needed, historical selected bids identifiers, and historical contract identifiers.

4. A system as defined in claim 1, wherein the plurality of request datasets includes a plurality of data elements selected from a list consisting of entity identifier, services requested, requested information, valuation, and proposed terms.

5. A system as defined in claim 1, wherein the plurality of proposal datasets includes a plurality of data elements selected from a list consisting of provider identifier, fee structure, services proposed, date submitted, and proposed terms.

6. A system as defined in claim 1, wherein the plurality of contract datasets includes a plurality of data elements selected from a list consisting of provider identifier, fee structure, date submitted, contract term, services rendered, and total contract value.

7. A system as defined in claim 1 wherein:
the plurality of provider datasets includes a plurality of data elements selected from a list consisting of contact information, services provided, bid criteria, historical bid information, and historical contract information;
the plurality of entity datasets includes a plurality of data elements selected from a list consisting of contact information, entity type, location, services needed, historical selected bids identifiers, and historical contract identifiers;
the plurality of request datasets includes a plurality of data elements selected from a list consisting of entity identifier, services requested, requested information, valuation, and proposed terms;
the plurality of proposal datasets includes a plurality of data elements selected from a list consisting of provider identifier, fee structure, services proposed, date submitted, and proposed terms; and
the plurality of contract datasets includes a plurality of data elements selected from a list consisting of provider identifier, fee structure, date submitted, contract term, selection process information, services rendered, and total contract value.

8. A system as defined in claim 1, wherein the DADM is configured to present to a user data elements from a prescribed contract dataset with corresponding data elements from a proposal dataset submitted by the provider of the services corresponding to the prescribed contract dataset, thereby enabling the user to assess any variation between the terms disclosed in the winning proposal and the terms of the corresponding contract.

9. A system as defined in claim 1, wherein the DADM is configured to receive document requests from a client device and to generate a submission to an entity for the requested document.

10. A method for providing bidding and contract information to a user, comprising:
providing access to users to a database management system (DMS) having data stored on a computer-readable medium, the DMS including
a plurality of provider datasets, each provider dataset having prescribed data elements regarding a provider of professional services, including a unique identifier assigned to the provider,
a plurality of entity datasets, each entity dataset having prescribed data elements regarding a purchaser for professional services, including a unique identifier assigned to each entity,
a plurality of request datasets, each request dataset having prescribed data elements regarding a request issued by an entity inviting providers of professional services to submit proposals, including a unique identifier assigned to each request,
a plurality of proposal datasets, each proposal dataset having prescribed data elements regarding a proposal submitted by a provider of professional services in response to a request issued by an entity, including a unique identifier assigned to each proposal, and
a plurality of contract datasets, each contract dataset having prescribed data elements regarding a contract for professional services between an entity and a provider of professional services, including a unique identifier assigned to each contract;
receiving search criteria from a client device through a communications network, the search criteria defining prescribed parameters attributable to one or more datasets of the DMS; and
transmitting search results based on the search criteria to the client device through the communications network.

11. A method as defined in claim 10, wherein the plurality of provider datasets includes a plurality of data elements selected from a list consisting of contact information, services provided, bid criteria, historical bid information, and historical contract information.

12. A method as defined in claim 10, wherein the plurality of entity datasets includes a plurality of data elements selected from a list consisting of contact information, entity type, location, services needed, historical selected bids identifiers, and historical contract identifiers.

13. A method as defined in claim 10, wherein the plurality of request datasets includes a plurality of data elements selected from a list consisting of entity identifier, services requested, requested information, valuation, and proposed terms.

14. A method as defined in claim 10, wherein the plurality of proposal datasets includes a plurality of data elements selected from a list consisting of provider identifier, fee structure, services proposed, date submitted, and proposed terms.

15. A method as defined in claim 10, wherein the plurality of contract datasets includes a plurality of data elements selected from a list consisting of provider identifier, fee structure, date submitted, contract term, services rendered, and total contract value.

16. A method as defined in claim 10, wherein:
the plurality of provider datasets includes a plurality of data elements selected from a list consisting of contact information, services provided, bid criteria, historical bid information, and historical contract information;
the plurality of entity datasets includes a plurality of data elements selected from a list consisting of contact information, entity type, location, services needed, historical selected bids identifiers, and historical contract identifiers;
the plurality of request datasets includes a plurality of data elements selected from a list consisting of entity identifier, services requested, requested information, valuation, and proposed terms;
the plurality of proposal datasets includes a plurality of data elements selected from a list consisting of provider identifier, fee structure, services proposed, date submitted, and proposed terms; and
the plurality of contract datasets includes a plurality of data elements selected from a list consisting of provider identifier, fee structure, date submitted, contract term, services rendered, and total contract value.

17. A method as defined in claim 10, further comprising transmitting to a client device data elements from a prescribed contract dataset with corresponding data elements from a proposal dataset submitted by the provider of the services corresponding to the prescribed contract dataset, thereby enabling a user to assess any variation between the terms disclosed in the winning proposal and the terms of the corresponding contract.

18. A method as defined in claim 10, further comprising generating a submission to an entity for a document, and populating data into the DMS with data from the document received from the entity in response to the submission.

19. A method as defined in claim 10, further comprising receiving document requests from a client device, and generating a submission to an entity for the requested document.

20. A method as defined in claim 19, further comprising populating data into the DMS with data from the document received from an entity in response to the submission.
